(19) United States
(12) Patent Application Publication
(10) Pub. No.: US 2007/0008954 A1
(43) Pub. Date: Jan. 11, 2007

(54) Method for transmitting audiovisual data using a mobile conversion device

(76) Inventor: Chao-Hung Wu, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/177,375

(22) Filed: Jul. 11, 2005

(51) Int. Cl. H04L 12/66; H04L 12/56

(52) U.S. Cl. 370/352; 370/401

(57) ABSTRACT

A mobile audiovisual data transmitting method is described. Thereof a mobile audiovisual data conversion device based on the communication between digital signals of IP packet is used. In the mobile audiovisual data conversion device, a signal conversion module is used, so that the computer on the transmission end or the receiving end can process a data transmission through a relay server connected to the Internet. The relay server has a lookup table for setting the transferring of the phone or computer on the target end so that the data can be transmitted from a mobile communication apparatus to a computer at the other side via the Internet by using the lookup table or from a computer to a mobile communication apparatus via the mobile audiovisual data conversion device and via a phone network by using the lookup table of the relay server.

### BACKGROUND OF THE INVENTION

1. Field of the Invention

This invention relates to a method for transmitting mobile audiovisual data, and more particularly to an audiovisual transmission and instantaneous message achieved by connecting to an indoor telephone device through a mobile audiovisual conversion device and coupling to a relay server of a connection network.

2. Description of Related Art

VoIP (Voice over IP) network telephone is a speech transmission service based on the Internet protocol after a speech signal is compressed into data packet. In other words, the applied telecommunication service of speech is transmitted through an open Internet. Through the Internet, not only an instantaneous but also a worldwide speech service can be provided so that the user can carry out a long distant telephone conversation without using the conventional PSTN (Public Switched Telephone Network).

VoIP is a real-time transmission of an analog voice signal in a data packet form on an IP network. In other words, a VoIP system digitizes the original voice analog signal and then processes an end-to-end instantaneous message through all kinds of related communication protocols on the network. Through VoIP, the distortion, echo and missing data, which appear during the transmission of a data packet on the network, can be properly repaired so as to reconstruct the original voice.

In practice, VoIP can be divided into three categories, PC-to-PC, PC-to-telephone, and telephone-to-telephone. PC-to-PC executes a computer-to-network communication software such as, for example, Skype or Net2Phome on a PC. If the two parties both have this software, then the direct communication by telephone can be achieved. PC-to-telephone executes a software on the PC, and after the PC is connected to a network and to the VoIP connection apparatus of the ISP, the user directly communicates by the household telephone. Telephone-to-telephone directly dials the VoIP apparatus of the ISP, which is already connected to the VoIP apparatus at the location of the other party. After dialing the telephone number through the local telecommunication network, communication can be achieved.

When using VoIP, the receiving and transmitting sides both have to connect to the Internet, and both have to own a fixed IP address so that the data transmission between the apparatuses of both sides is achieved through IP addresses. Therefore, IP acquirement is the prerequisite for utilizing VoIP. If the IPs for both sides cannot be obtained, then the communication cannot be achieved.

In addition to being a cheap substitute for long-distance calls, VoIP may also be favored by the public due to the related services combining voice and data, such as listening to email by phone, since most media, with the exception of voice, may use IP.

In the prior art, exemplified by TW Patent No. 530473 “Portable network telephone device”, a portable network telephone device is disclosed, which can be simultaneously connected to a data network, a telephone switch system, and a telephone device.

Further, in TW Patent No. 512619 “Speech of speech system based on Internet Protocol”, a speech application used in an IP carried speech protocol network is disclosed for realizing speech signal transmission through an IP network.

However, the above-described conventional VoIP communications are both provided by the telecommunication system, and the phone subscriber utilizes the uplink to connect to the Internet, to the downlink of the other side and then to the local switchboard system for achieving the network transmission of a speech packet.

Reference is made to FIG. 1, showing a schematic view of the prior art exemplified by the above-described application, which is a VoIP system of the conventional phone-to-phone architecture. The user can use telephone 11 to call phone 12 at the other side. If saving the charge in a manner of signal adaptation and then passing to the Internet is necessary, the pathway must pass through a charging system 10.

The user utilizes the local phone 11 to call the charging system 10, to connect to the Internet 15 through an uplink computer 16 passing through the uplink switchboard 13 provided by the system, to connect to a phone switchboard system represented by the local switchboard 14 through a downlink computer 18, and then to call the target phone 12. The phone 12 can be a cell phone or a general household telephone, and the charging system 10 usually includes devices such as, for example, a commercial telephone switchboard, or a computer server connected to a network, thereby making an inbound communication signal outbound to telephone switch systems in two locations.

FIG. 2 shows the application of the conventional computer-to-computer technology, which utilizes the network communication software loaded on the computer 21 to connect to the phone at the other side through the Internet 15. However, the application needs to pass through the charging system 20 shown in FIG. 2, and the relative system providers may provide the downlink computer 18 connected to the Internet 15 and connected to the downlink switchboard 14 so that the data packet transmitted on the network can be converted into a general analog speech signal. Finally, the user on the other side answers the phone 12.

As described in FIGS. 1 and 2, when the user wants to make a long distance call, he or she, in addition to paying the local telephone bill, also needs to pay the local telephone bill of the other location. Further, the user also has to pay a commercial service charge as a result of using the charging system 10, 20.

### SUMMARY OF THE INVENTION

The present invention provides a method for transmitting audiovisual data using a mobile conversion device, in which audiovisual data is transmitted from a mobile communication device to a device on the other side via the mobile communication apparatus, and by using a relay server coupled to the Internet, to connect the computers on two ends or from a computer to a mobile communication device. The above-described mobile audiovisual data conversion device includes an analog-to-digital conversion function, a dialing function, and a function of connecting to a computer or a telephone device by a communication port mounted therein.

In a preferred embodiment, the steps of the method according to the present invention include the following. A call is made through a local end phone through by dialing a communication device. A communication signal is transmitted to a mobile audiovisual conversion device, such as VoIP, converting the communication signal to a digital signal. The digital signal is transmitted to a relay server connected to the Internet. The digital signal is propagated to a target end computer via the Internet. The digital signal is transmitted to a mobile audiovisual conversion device on the target end. The digital signal is converted into an analog signal. The analog signal is transferred to a phone on the target end. A receiving phone is called. A connection is made between the communication device on the local end and the receiving phone.

According to another embodiment of the present invention, the method includes the following steps. A call is dialed through a local end phone via a communication device. A communication signal is transmitted to a mobile audiovisual conversion device. The communication signal is converted into a digital signal. The digital signal is transmitted to a relay server connected to the Internet. The digital signal is propagated to a portable computer on the target end via Internet. A connection is made between the communication device on the local end and the receiving phone.

According to a further embodiment of the present invention, the method includes the following steps. A portable computer is connected to the Internet; a communication signal is transmitted to a relay server connected to the Internet. The communication signal is transmitted to a mobile audiovisual conversion device on the target end. The communication signal is converted into an analog signal. The analog signal is transferred to a receiving phone and an outside connection is dialed. A connection is made between the portable computer on the local end and the communication device.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows an architecture of a conventional phone-to-phone VoIP system;

FIG. 2 shows an architecture of a conventional computer-to-phone VoIP system;

FIG. 3 is a schematic view showing a first embodiment of the present invention;

FIG. 4 is a flow chart showing a first embodiment of the present invention;

FIG. 5 is a schematic view showing a second embodiment of the present invention;

FIG. 6 is a flow chart showing a second embodiment of the present invention;

FIG. 7 is a schematic view showing a third embodiment of the present invention;

FIG. 8 is a schematic view showing a fourth embodiment of the present invention; and

FIG. 9 is a flow chart showing a third embodiment of the present invention.

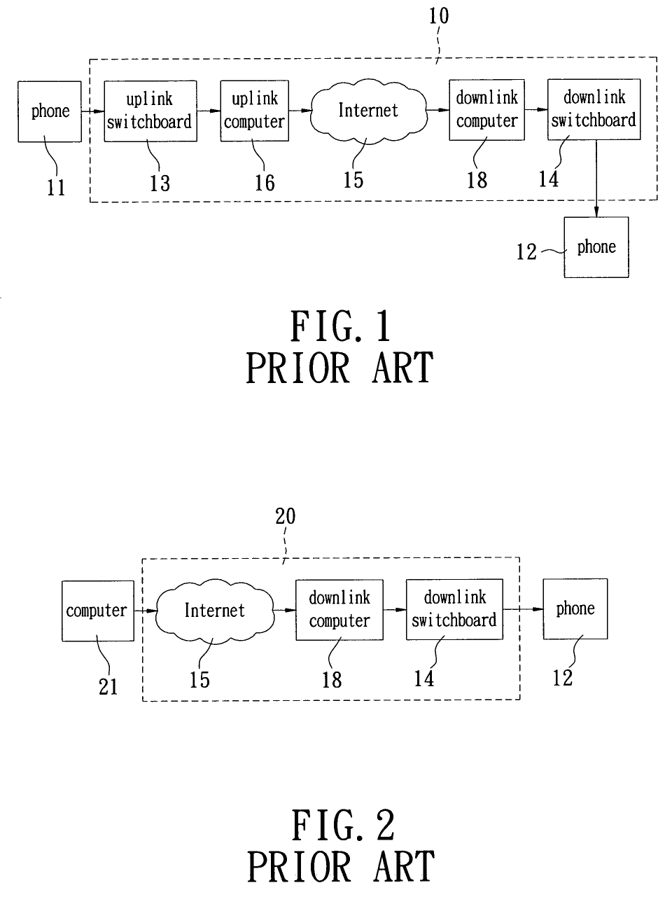

### DETAILED DESCRIPTION OF PREFERRED EMBODIMENTS

In a conventional VoIP device, the analog speech signal is converted into a speech packet for transmission by the data network through a switchboard. Then, the speech packet is transmitted to the receiving end, and again converted into an analog speech signal by the switchboards for reception by a regular phone or a cell phone. Alternatively, both sides have to own a VoIP phone with a VoIP function therein. Firstly, an IP address and other necessaries must be established. Then, communication can be established. The main purpose of the VoIP device is to lower the telephone bill in a manner of an instantaneous phone.

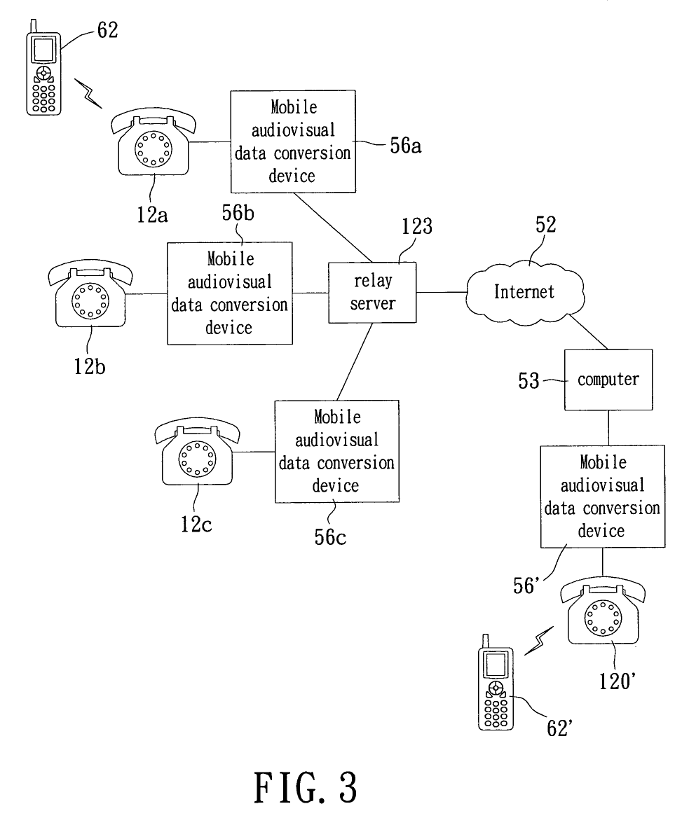

In the schematic view of the embodiment according to the present invention shown in FIG. 3, in this embodiment, a relay server 123 connected to Internet 52 is included as a relay server for the local end and the target end. A lookup table, which is relayed from the local end to the target end via the Internet, is also included.

On the local end, plural local end phones 12a, 12b, 12c are respectively connected to mobile audiovisual data conversion devices 56a, 56b, 56c, thereby coupling to the relay server 123. The mobile audiovisual data conversion devices 56a, 56b, 56c, which are respectively connected to the phones 12a, 12b, 12c, at least possess the modem function and the analog-to-digital conversion function of the dialing phone, and also can utilize a function switch to determine the relay server 123 must be connected to. Moreover, communication data transmitted from the other side can be converted by these mobile audiovisual data conversion devices 56a, 56b, 56c, and transmitted to the phone device through dialing, or transmitted to the other side by the relay server 123 via Internet 52.

On the other side of Internet 52, a computer connected to the network is installed. The computer 53 on the target end is set to transfer the received phone, such as, for example, the target phone 120′ shown in FIG. 3, and is connected to the transferred target end phone 120′ through the mobile data conversion device 56′ on the target end. The computer 53 calls the target end phone 120′ through the dialing function of the mobile data conversion device 56′, and further transfers to a mobile communication apparatus 62′ on the target end.

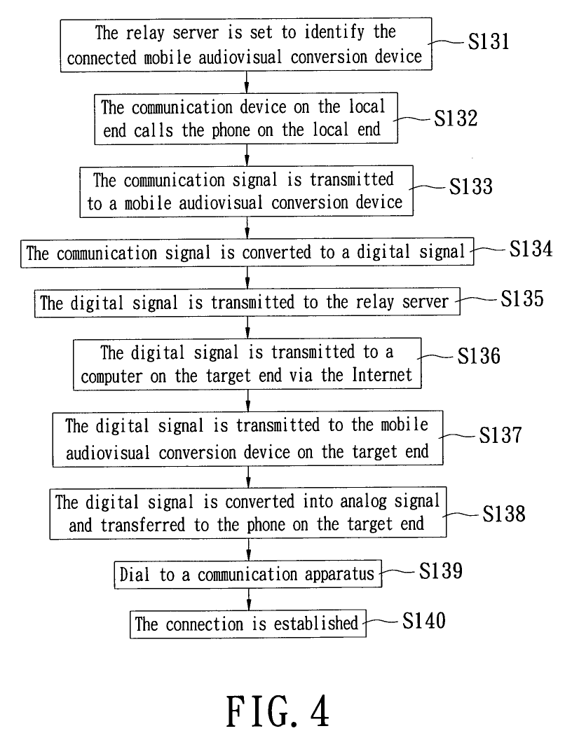

In the preferred embodiment shown in FIG. 3, the mobile communication apparatus 62 on the local end is connected to one of the local end phones 12a, 12b, 12c, such as the local end phone 12a, through dialing. Through the mobile audiovisual data conversion device 56a and the relay server 123 connected therebetween, the communication data can be transmitted to the other side via Internet 52, received by the computer 53 on the target end, converted by the mobile audiovisual data conversion device 56′, transmitted to the target end phone 120′, and further connected to the mobile communication apparatus 62′ on the target end. Therefore, the purpose of reducing a long-distance phone bill or facilitating data transmission can be achieved through the performance manner that transmits speech or an audiovisual packet via the Internet 52. The above-described mobile communication apparatuses 62, 62′ can be cell phones, PDAs, or mobile communication apparatuses with a cell phone function, and the data transmission between the local end and the target end can be the image and voice signal. The transmission flow chart of the audiovisual data is shown in FIG. 4.

Before starting the steps of the method for transmitting audiovisual data illustrated in FIG. 4, the transferring interface software in the relay server is set by using the computer on the target end. The relay server is set to identify the connected mobile audiovisual conversion device (step S131), and then, the communication device on the local end calls the phone on the local end (step S132). After putting the line through, the communication signal is transmitted to a mobile audiovisual conversion device (step S133). Then, the communication signal is converted to a digital signal by the mobile audiovisual conversion device (step 134), and the digital signal is transmitted to the relay server, which is connected to the Internet (step S135) depending on the contents of the communication signal and the lookup table for transferring the phone or the computer on the target end in the server, which may comprise a comparison table for IPs or MAC addresses of the computers on two sides, or member numbers of video conference. The digital signal is transmitted to a computer on the target end via the Internet according to this lookup table (step S136). When the computer on the target end is shut down, the audiovisual or speech message of the communication can be stored in the memory of the relay server, or when the computer on the target end is under using, it can be previously transmitted to the mobile audiovisual conversion device on the target end according to the transferring setting (step S137), converted into analog signal, transferred to the phone on the target end through the dialing function contained therein (step S138), and dialed to a communication apparatus, such as a mobile phone or other wireless communication apparatus, according to the setting (step S139). The connection between the communication device on the local end and the receiving communication apparatus is thus established.

The transmission procedure above also can be reversed. In other words, it can be dialed from the target end to the local end and transferred to a designated communication apparatus by the tagging server.

It is noted that the relay server can be located on the local end, such as the relay server in a company, so that when a line comes, it can be transferred to the target computer according to the lookup table, or can be located in a third location other than the local end and the target end. The local end lacking the relay server can thus be firstly connected to the Internet by a network bridge for further connection to this relay server, and then the communication signal can be transferred to the target end by the transferring function therein.

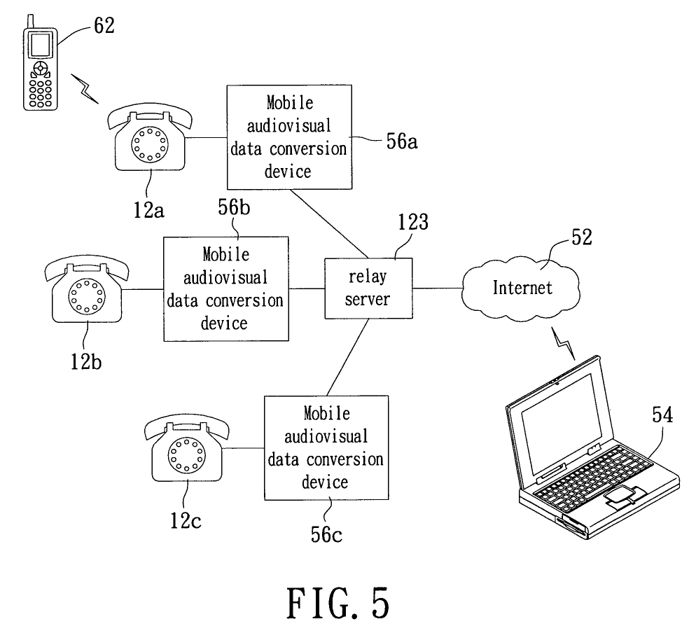

FIG. 5 is a schematic view showing a second embodiment according to the present invention. The receiving apparatus on the target end can be a portable computer 54 connected to the Internet 52, and the portable computer can dial one of the local end phones 12a, 12b, 12c through the communication apparatus on the local end, such as the mobile communication apparatus 62, connected to mobile audiovisual data conversion devices 56a, 56b, 56c, respectively, through each phone and converted thereby, and transmitted to Internet 52 through the relay server 123. According to the transferring and corresponding lookup table in relay server 123, it can search for the portable apparatus on Internet 52, such as the shown portable computer 54. Finally, the audiovisual or voice contents can be transmitted to the portable computer 54 via the Internet 54. In another embodiment, the portable computer 54 can reversely transmit the communication contents, like audiovisual data, back to the local end.

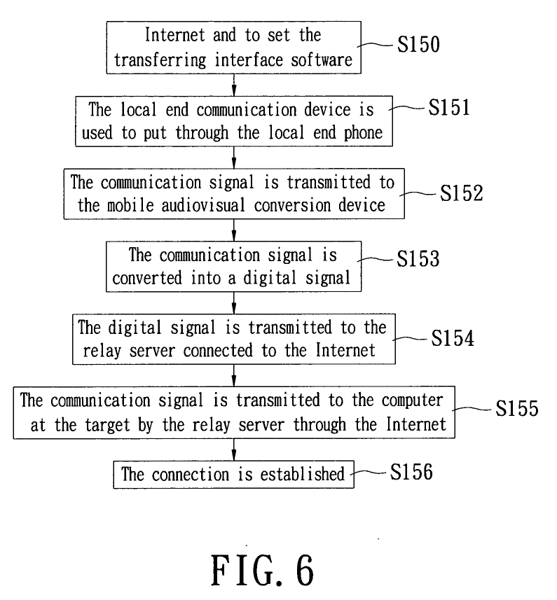

FIG. 6 shows the flow chart of the above-described second embodiment having the following steps.

Before this embodiment is performed, a relay server must be mounted on the local end. In practice, the relay server can be mounted in a third location other than the local end and the target end according to the practical demand and needs to connect to the Internet. A function of transferring the receiving device on the target end is included and also a lookup function, in which the information about the target end is recorded for transferring the speech or audiovisual packet on the Internet, and the mobile audiovisual conversion device arranged on the local end can include functions of dialing and analog-to-digital conversion.

The computer on the target end is used to access the relay server through the Internet and to set the transferring interface software (step S150). Then, the local end communication device, a device with mobile communication ability, such as, for example, a mobile phone or a PDA, is used to put through the local end phone. This can be achieved by, for example, dialing (step S151). Then, the communication signal is transmitted to the mobile audiovisual conversion device (step S152) so that the communication signal is converted into a digital signal (S153). In this case, the signal transmitted by the local end phone is a conventional analog signal, but is not limited thereto in practice. Then, the digital signal is transmitted to the relay server connected to the Internet (S154), and through the signal transferring function thereof and according to the contents of the communication signal, it can determine the destination of the reception such that the digital signal can be transmitted to the target computer by the relay server. When the computer on the target end is shut down, the audiovisual message of the communication signal can be stored in the memory of the relay server, or when the computer on the target end is in use, the communication signal is transmitted to the computer at the target by the relay server through the Internet (S155). In this case, for example, a portable computer such as a notebook can be used. After being put through, the communication software contained therein can be used to receive or transmit the speech or audiovisual signal. Finally, the connection between the communication device on the local end and the portable computer is established (step S156), and after the connection is established, the transmitted data can be audiovisual and voice signals.

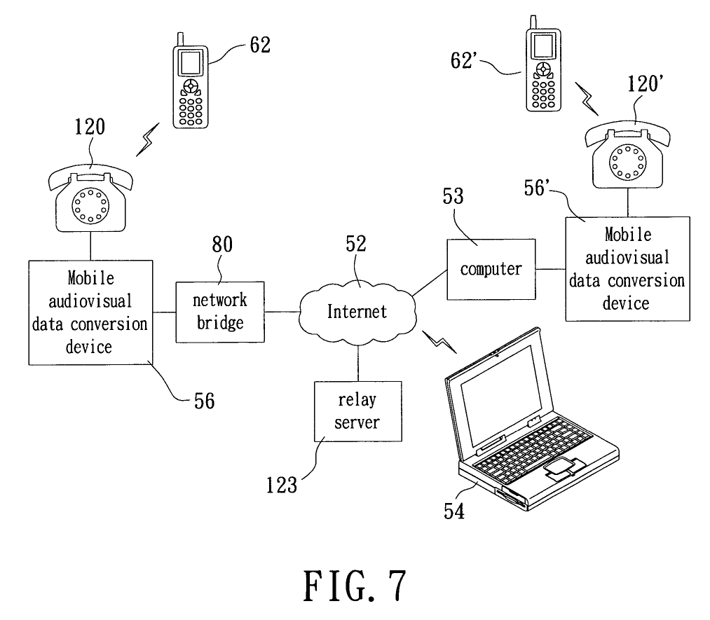

FIG. 7 is a schematic view showing a third embodiment according to the present invention. The characteristic of this embodiment is that the relay server 123 is installed in a third location, other than the local end or the target end, according to demand. Since the relay server is connected to the Internet 52, it is suitable for personal use, which is different from commercial use. The provision of this relay server 123 with the function of transferring the receiving device on the target end by a third party allows the user to use the mobile communication apparatus 62 to dial the phone 120 on the local end, and then, through connecting the mobile audiovisual data conversion device 56 to the Internet 52 via a network bridge 80 (which can be an IP sharer, router, or modem), which is connected to Internet 52, the communication signal can be transmitted to the relay server 123. By making the transferring function cooperate with the lookup table, the speech or audiovisual packet can be transferred to the target end on Internet 52 according to the information about the record of target end. The apparatus of the receiving end can be a portable computer 54 or a general desktop for facilitating the receiving of speech or audiovisual signal at any time and any location so as to achieve a bi-directional communication. The receiving end also can be the computer 53 shown in the drawing, by which the communication signal can be received and the speech or audiovisual information can be transmitted to the telephone 120′ at a target end via the mobile audiovisual data conversion device 56′ on the target end and can further be transferred to and received by the mobile communication apparatus 62′. Therefore, the purpose of saving outlay can be achieved because the audiovisual data is transmitted on the Internet 52 in the form of digital signals.

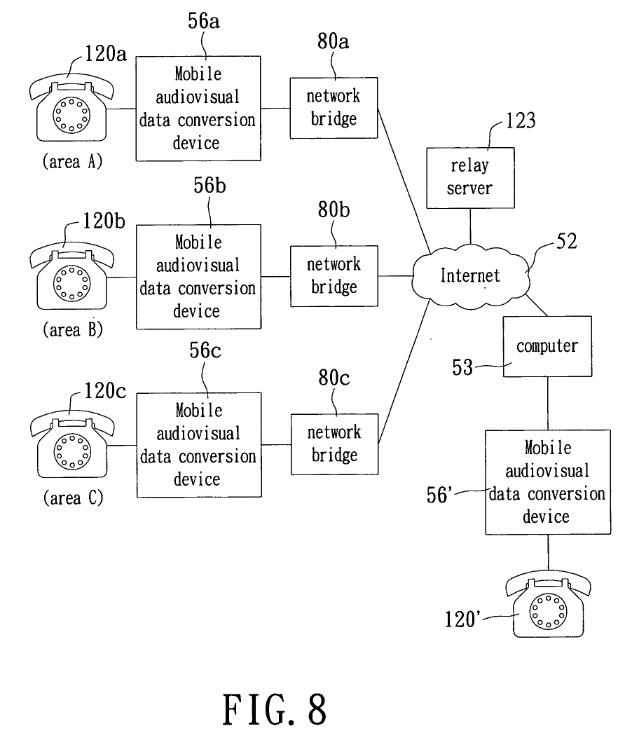

FIG. 8 is a schematic view showing a fourth embodiment according to the present invention. In the present invention, the connection relationship of each device, the mobile audiovisual conversion device which is operated like the VoIP device, and the relay server with the functions of transferring and lookup table all can be applied to the transferring communication across countries and regions.

As shown in the drawing, the head office needs to have a telephone 120′ connected to the mobile audiovisual conversion device 56′ and connected to the Internet 52 through a computer 53 or an apparatus connected network (e.g., network bridge, or network sharer). If it is intended to establish the branch companies or service centers in Area A, Area B, and Area C, then only corresponding software and hardware need to be set up. For example, Area A at least includes telephone 120a, mobile audiovisual conversion device 56a and the network bridge 80a. Area B at least includes telephone 120b, mobile audiovisual conversion device 56b and the network bridge 80b. Area C at least includes telephone 120c, mobile audiovisual conversion device 56c and the network bridge 80c. The telephone is connected to the mobile audiovisual conversion device and connected to the Internet 52 through the network bridge.

For employees, clients or product users in Areas A, B, C, the communication data can be transmitted to the Internet 52 by dialing the local end phones 120a, 120b, 120b, through conversion by the mobile audiovisual conversion device 56a, 56b, 56c into digital signals, then through transferring the network bridges 80a, 80b, 80c to corresponding destinations via the relay server 123, reception by the computer 53 connected to the Internet inside the head office or by the connecting device, conversion by the mobile audiovisual conversion device 56′, and transmission to the phone 120′ or transferring to a mobile communication device such as a mobile phone, a PDA, or a portable computer. In the embodiment above, through the relay server 123 applied to the communication in each branch company, each branch company only needs to set up the apparatus provided by the present invention, and then any phone can be transferred to the head office or branch company so that the purposes of outlay saving and limitless communication can be achieved.

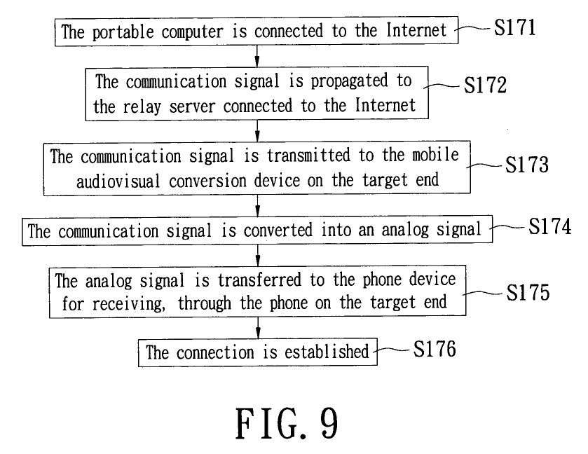

FIG. 9 is a flow chart showing the embodiment where the connected portable computer communication transmits data.

In this embodiment, the relay server, connected to Internet and provided by the third party, is mounted in the third party other than the local end and the target end according to demand. The function of transferring a target end receiving device is provided and the receiving target end also needs to connect to the Internet through an apparatus like the network bridge.

After the portable computer is connected to the Internet (step S171), the communication signal is propagated to the relay server connected to the Internet (step S172). Through the transferring function of the relay server, the communication signal is transmitted to the mobile audiovisual conversion device on the target end (step S173) and converted into an analog signal (step S174). Then, the analog signal is transferred to the phone device for receiving, such as a mobile phone, through the phone on the target end (step S175), and the connection between the portable computer and the communication apparatus on the target end is established (step S176).

Through the method for transmitting audiovisual data according to the present invention, the audiovisual data can be transmitted, via the mobile audiovisual data conversion device, from the mobile communication apparatus to the device on the other side, or transmitted from the computer to the mobile communication device, or between the mobile communication devices respectively in two locations. Moreover, by the mobile communication apparatus and a general phone device cooperating with a mobile audiovisual data conversion device such as VoIP and the lookup table in a relay server for dialing, the digital signal can be converted into the analog signal and transmitted to the mobile communication apparatus via the Internet or a phone network. The purposes of saving the outlay of speech or audiovisual signal transmission and individualizing are thus achieved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for transmitting audiovisual data using a mobile conversion device, comprising the steps of: dialing a local end phone through a communication device; transmitting a communication signal to a mobile audiovisual conversion device;
converting the communication signal to a digital signal;
transmitting the digital signal to a relay server connected to an Internet;
propagating the digital signal to a target end computer via the Internet;
transmitting the digital signal to a mobile audiovisual conversion device on a target end;
converting the digital signal into an analog signal;
transferring the analog signal to a phone on the target end;
dialing a receiving phone; and establishing a connection between the communication device on the local end and the receiving phone.

2. The method according to claim 1, wherein before the steps, the relay server is connected for executing a setting of transferring.

3. The method according to claim 1, wherein when the computer on the target end is shut down, the communication message is stored in the relay server.

4. The method according to claim 1, wherein the computer on the target end has to be set to designate a receiving phone for transferring.

5. The method according to claim 1, wherein the communication device is a mobile phone, a PDA or a mobile communication apparatus having the function of a cellular phone.

6. The method according to claim 1, wherein the relay server has a lookup table for transferring the phone on the target end via the Internet.

7. The method according to claim 1, wherein data transmitted after establishing the connection is an image and voice signal.

8. The method according to claim 1, wherein the mobile audiovisual conversion device comprises functions of dialing and analog-to-digital conversion.

9. The method according to claim 1, wherein the relay server is located on the local end.

10. The method according to claim 1, wherein the relay server is located in a third location connected to the Internet.

11. A method for transmitting audiovisual data using a mobile conversion device, comprising steps of:
dialing a local end phone through a communication device;
transmitting a communication signal to a mobile audiovisual conversion device;
converting the communication signal to a digital signal;
transmitting the digital signal to a relay server connected to an Internet;
propagating the digital signal to a portable computer on a target end via Internet; and
establishing a connection between the communication device on a local end and the receiving phone.

12. The method according to claim 11, wherein when the portable computer on the target end is shut down, the communication message is stored in the relay server.

13. The method according to claim 11, wherein the relay server has a lookup table for transferring the portable computer on the target end via Internet.

14. The method according to claim 11, wherein data transmitted after establishing the connection is an image and voice signal.

15. The method according to claim 11, wherein the mobile audiovisual conversion device comprises functions of dialing and analog-to-digital conversion.

16. The method according to claim 11, wherein the relay server is located on the local end.

17. The method according to claim 11, wherein the relay server is located in a third location connected to the Internet.

18. The method according to claim 11, wherein the portable computer is connected to the Internet in a wireless manner.

19. A method for transmitting audiovisual data using a mobile conversion device, comprising steps of:
connecting a portable computer to an Internet;
propagating a communication signal to a relay server connected to the Internet;
transmitting the communication signal to a mobile audiovisual conversion device on a target end by transferring of the relay server;
converting the communication signal into an analog signal;
transferring the analog signal to a receiving phone by transferring a phone on the target end to the phone device; and
establishing a connection between the portable computer on the local end and the communication device.

20. The method according to claim 19, wherein before the steps are performed, the relay server is connected for executing a setting of transferring.

21. The method according to claim 19, wherein the communication signal is capable of being stored in the relay server.

22. The method according to claim 19, wherein the relay server has a lookup table for transferring the phone on the target end via the Internet.

23. The method according to claim 19, wherein data transmitted after establishing the connection is an image and voice signal.

24. The method according to claim 19, wherein the mobile audiovisual conversion device comprises functions of dialing and analog-to-digital conversion.

25. The method according to claim 19, wherein the relay server is located on the local end.

26. The method according to claim 19, wherein the relay server is located in a third location connected to the Internet.

27. The method according to claim 19, wherein the portable computer is connected to the Internet in a wireless manner.
